(19) United States
(12) Patent Application Publication
(10) Pub. No.: US 2003/0159471 A1
(43) Pub. Date: Aug. 28, 2003

(54) Method for fabricating fiber optic joints

(75) Inventor: Ting-An Wang, Taipei (TW)

Correspondence Address: Jackson Walker L.L.P., Suite 2100, 112 E. Pecan Street, San Antonio, TX, 78205, US

(73) Assignee: WAMIN OPTOCOMM MFG. CORPORATION

(21) Appl. No.: 10/124,193

(22) Filed: Apr. 17, 2002

(30) Foreign Application Priority Data
Feb. 27, 2002 (TW) 091103538

(51) Int. Cl. C03B 37/15

(52) U.S. Cl. 65/410

(57) ABSTRACT

A method for fabricating fiber optic joints uses two fiber optic cables, a tray to hold the two fiber optic cables and a connecter for connecting one of the fiber optic cables being joined to a fiber optic jumper cable. The two fiber optic cables are held on the tray to be easily transported among manufacturing stations and reduce the transport time by about 50%. The connector conveniently connects or disconnects the fiber optic cable and the fiber optic jumper cable. Therefore the present invention effectively decreases the manufacturing period and increases the quantity of joints manufactured in the same amount of time.

### BACKGROUND OF THE INVENTION

1. Field of the Invention

The present invention relates to a method for fabricating fiber optic joints, and more particularly to a method that can be used to mass-produce large quantities of fiber optic joints.

2. Description of Related Art

A conventional method of fabricating fiber optic joints has process stations, such as fusing stations, heat shrinking tube stations and steel tube stations. With reference to FIG. 5, fabricating a fiber optic joint uses a spool of fiber optic cable (50), a piece of fiber optic cable (51), a fiber optic jumper cable (53), a light source (60) having a light terminal (601), a light detector (61) and a joint workstation (52) in a fusing station.

The optical fiber fusing process in the fusing station comprises the steps of striping covers off the optical cable (50) on the spool and the piece of fiber optic cable (51) to expose the bare optical fibers (not shown), cleaning the bare optical fiber to ensure the cover has been completely removed from the bare optical fiber, fusing the fiber optic jumper cable (53) and the optical cable (50) on the spool to connect the optical cable (50) on the spool to a terminal (601) of a light source (60) and fusing the two optical cables (50, 51) to a fiber optic joint (not shown). Fusing the two optical cables (not shown) is the main operation in the fusing station. However, Other procedures must be completed before the two optical fibers can be fused together. For example, the fiber optic jumper cable (53) used to connect the fiber optic cable (50) on the spool to the light source (60) to avoid damaging the expensive light terminal (601) in the light source (60) must be periodically disconnected from and reconnected to the fiber optic cable (50) on the spool. When the fiber optic cable (50) on the spool is depleted, the fiber optic jumper cable (53) must be disconnected from the fiber optic cable (50) on the spool and reconnected to the fiber optic cable (50) on a new spool. However, fusing the fiber optic jumper cable (53) and the fiber optic cable (50) on the new spool requires too much time.

Because many steps must be accomplished before actually fusing the two optical cables to form the fiber optic joint in the fusing station, the fusing station requires the most time in the manufacturing sequence and is the cause of low manufacturing quantities.

Therefore, an objective of the present invention is to provide an improved method for fabricating fiber optic joints to mitigate and/or obviate the aforementioned problems.

### SUMMARY OF THE INVENTION

The main objective of the method for fabricating fiber optic joints in accordance with the present invention is to increase the quantity of fiber optic joints that can be manufactured in a specified amount of time.

Other objects, advantages and novel features of the invention will become more apparent from the following detailed description when taken in conjunction with the accompanying drawings.

### BRIEF DESCRIPTION OF THE DRAWINGS

FIG. 1 is an operational equipment diagram of a fusing station used to carry out a method for fabricating fiber optic joints in accordance with the present invention;

FIG. 2 is a flow chart of a method for the fabricating fiber optic joints in accordance with the present invention;

FIG. 3 is an operational top plan view of a fusing station used to carry out the method for fabricating fiber optic joints in FIG. 1;

FIGS. 4A to 4E are perspective views of the partial products of the method for fabricating fiber optic joints in accordance with the present invention; and

FIG. 5 is an operational equipment diagram of a fusing station used to carry out a conventional method for fabricating fiber optic joints in accordance with the prior art.

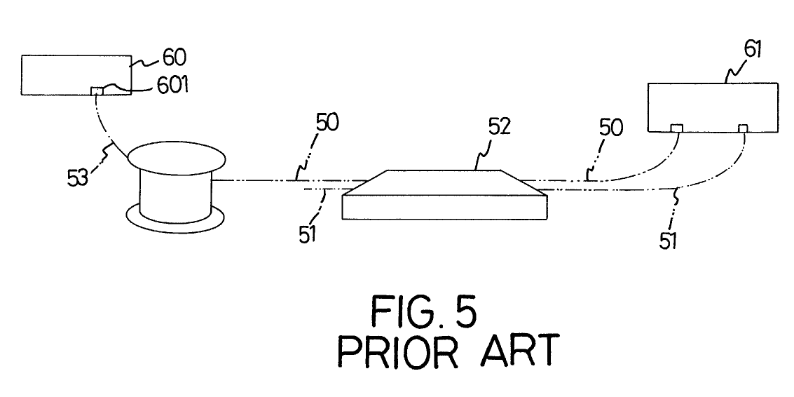

### DETAILED DESCRIPTION OF THE PREFERRED EMBODIMENT

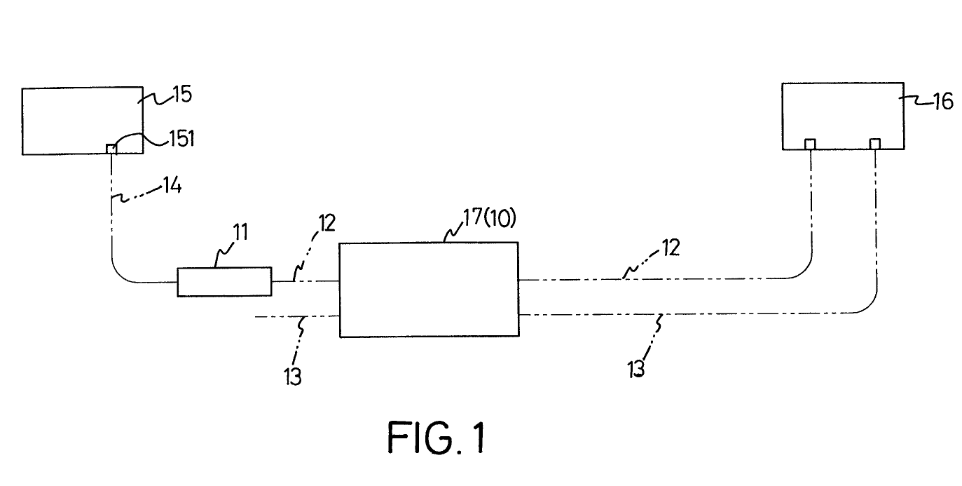

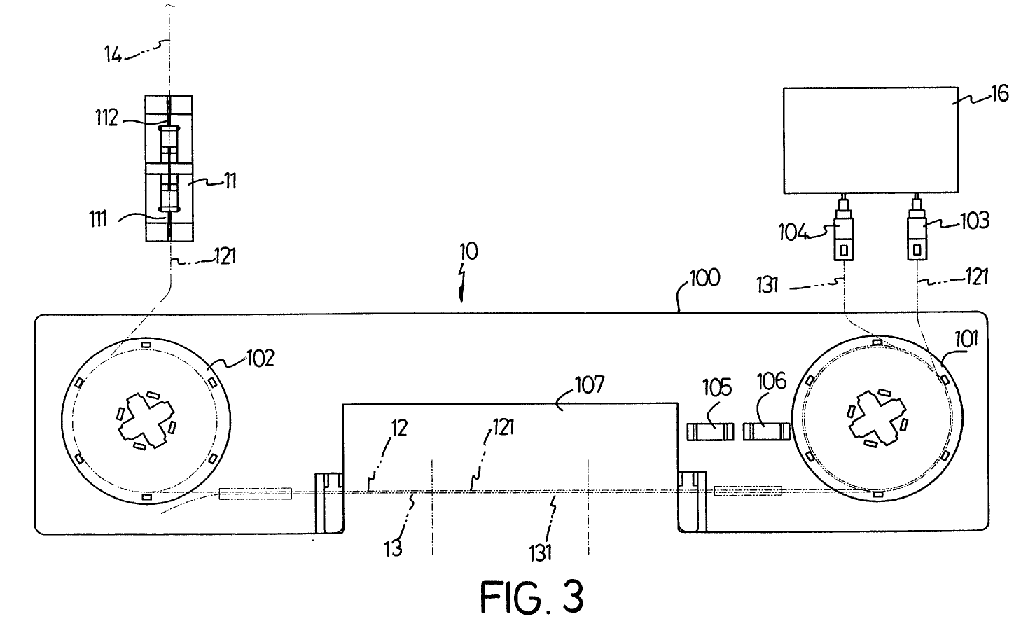

With reference to FIG. 1, fabricating a fiber optic joint in accordance with the present invention is accomplished through the use of a first fiber optic cable (12), a second fiber optic cable (13), a fiber optic jumper cable (14), a light source (15) having a light terminal (151), a light detector (16), a tray (10) and a joint workstation (17). With additional reference to FIG. 3, both the first and the second fiber optic cables (12, 13) have two ends, a fiber optic filament (121, 131) and a protective cover (not shown) on the fiber optic filament (121, 131).

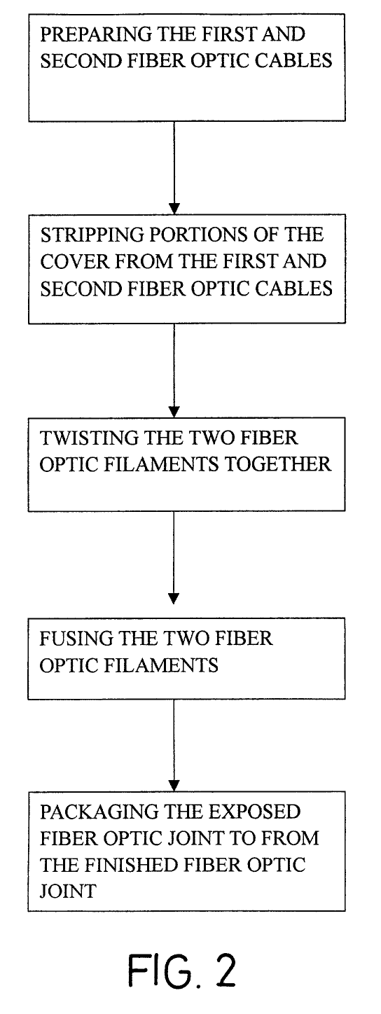

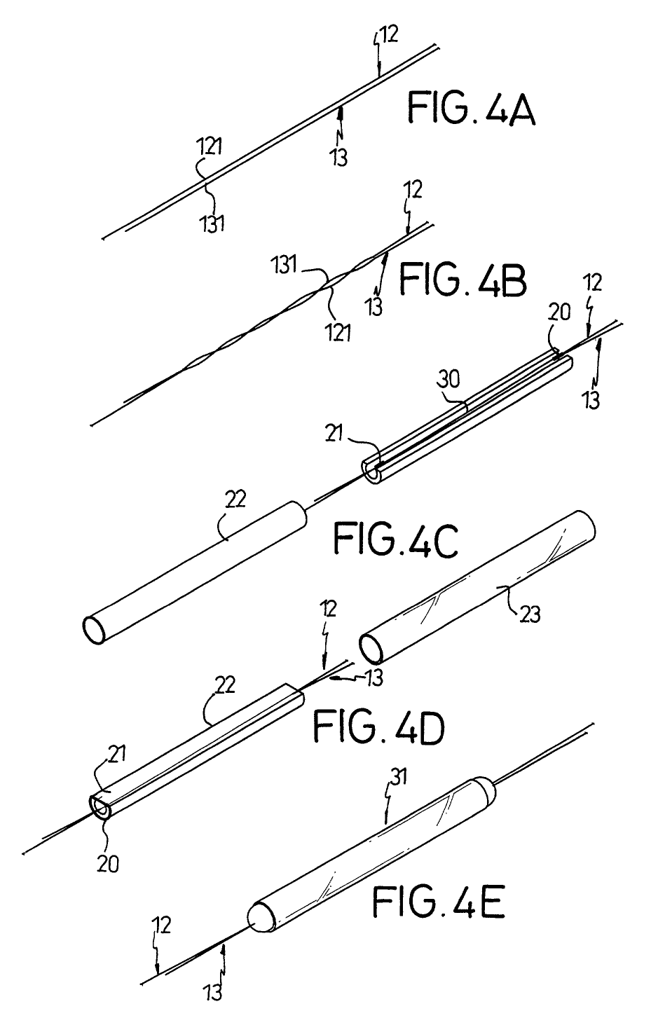

With reference to FIGS. 1, 2 and 4, the method for manufacturing fiber optic joints comprises the steps of (i) preparing the first and second fiber optic cables (12, 13), (ii) stripping portions of the cover (not shown) from the first and second fiber optic cables (12, 13) to expose the fiber optic filament (121, 131), (iii) twisting the two fiber optic filaments (121, 131) together on a joint workstation (17) tray (10), (iv) fusing the two fiber optic filaments (121, 131) to form an exposed fiber optic joint (30), and (v) packaging the exposed fiber optic joint (30) in a heat shrinking tube station (not shown) and a steel tube station (not shown) to form the finished fiber optic joint (31).

Multiple first and second fiber optic cables (12, 13) are cut from a spool of fiber optic cable (not shown) by a cutting means, such as a precision cutting machine or a laser cutter, to ensure that each end of each fiber optic cable is a flat transverse cross sectional plane to decrease the light power loss. Then the cover on the first and second fiber optic cables (12, 13) have to be stripped the two ends and a middle segment of the first and second fiber optic cables (12, 13) to expose the fiber optic filament (121, 131). The fiber optic filament (121) at one end of the first fiber optic cable (12) is connected to the fiber optic jumper cable (14) by means of a connector (11). The fiber optic jumper cable (14) is connected to the light terminal (151) of the light source (15). The fiber optic filament (121) at the other end of the first fiber optic cable (12) is connected to the light detector (16). The fiber optic filament (131) at one end of the second fiber optic cable (13) is connected to the light detector (16). The fiber optic filaments (121) (131) at a middle segment of the first and second fiber optic cable (12, 13) are twisted together.

With reference to FIG. 3, the first and the second fiber optic cables (12, 13) put on the tray (10). The tray (10) has a base (100), two bobbins (101, 102) formed on two opposite positions on the base (100), two clips (105, 106) formed on the base (100) near one of the bobbins (101) for separately retaining two adapters (103, 104) therein and an opening (107) defined in middle portion of one edge of the base (100). Two grooves (111, 112) defined in the connector (11) provides that the fiber optic filament (121) of the first fiber optic cable (12) and the fiber optic jumper cable (14) retain in the two grooves (111, 112) and connect together.

When the first and the second fiber optic cables (12, 13) are put on the tray (10), the fiber optic filament (121) at one end of the first fiber optic cable (12) connects to one of the adapters (103) that is inserted into the light detector (16). The fiber optic filament (121) at the other end of the first fiber optic cable (12) is held in one of grooves (111) in the connector (11). The fiber optic filament (131) at one end of the second fiber optic cable (13) connects to the other adapter (104) and is inserted into the light detector (16). When the two fiber optic cable (12, 13) are put on the tray (10), the exposed fiber optic filaments (121, 131) in the middle segments of the first and second fiber optic cables (12, 13) correspond to the opening (107) of the tray (10) are twisted together, as shown in FIGS. 3A and 3B. Then the exposed fiber optic filaments (121, 131) in the middle segments of the first and second fiber optic cables (12, 13) are fused together to form the exposed fiber optic joint (30). During the fusing the two fiber optic cables (12, 13) step (iv), light from the light source (15) passes through the second fiber optic cable (13) to the light detector (16). As the fiber optic filaments (121, 131) of the first and the second fiber optic cables (12, 13) are fused together, a portion of light in the fiber optic filament (121) of the first fiber optic cable (12) is split off into the fiber optic filament (131) of the second fiber optic cable (13). The amount of light split off into the fiber optic filament (131) of the second fiber optic cable (13) depends on the degree to which the fiber optic filaments (121, 131) of the first and the second fiber optic cables (12, 13) are fused together. Therefore, fusing of the first and the second fiber optic cables (12, 13) can be monitored and controlled by measuring the intensity of light through each of the fiber optic cables (12, 13) at the light detector (16). The light detector (16) also has a proofing function to change the value of the light intensity detected from the first optical fiber cable (12) to 100% to ignore uncertain factors which cause attenuation of the light intensity between the fiber optic jumper cable (14) and the first optical fiber unit (12) before fusing the two fiber optic filaments (121, 131).

With reference to FIGS. 1, 2, 3C and 3D, the packaging processes is performed at the joint workstation (17). A split glass tube (20) is brought up from below of the exposed fiber optic joint (30) through the opening (107) in the tray (10) such that the exposed fiber optic joint (30) is positioned inside the split glass tube (20). Glue (21) is used to mount and hold the exposed fiber optic joint (30) in the split glass tube (20). With the exposed fiber optic joint (30) glued in the split glass tube (20), the tray (10) is transported to heat shrinking tube station where a heat shrink tube (22) is positioned around the exposed fiber optic joint (30) and split glass tube (20) to form a partial product (not numbered). The tray (10) then transports the partial product to a steel tube station where a steel tube (23) is mounted around the exposed fiber optic joint (30), split glass tube (20) and heat shrunk tube (22) partial product to complete the manufacture of a finished fiber optic joint (31), as shown in FIG. 3E.

According to the forgoing description, the spool of fiber optic cable is cut into multiple fiber optic cables (12, 13) and segments of the cover are stripped from the fiber optic cables (12, 13) before fusing two fiber optic filaments (121, 131) to manufacture the fiber optic joint (31) in the joint workstation (17), so that the two fiber optic cables (12, 13) can be directly fused in the joint workstation (17). Therefore the manufacturing speed increases in the joint workstation (17). Besides, the tray is used to carry the two fused fiber optic cables (12, 13) to make sending the two joined fiber optic cables to package process stations easier. The time required to send fiber optic joint among the manufacturing processes in the present invention will reduce the conventional fabricating flow time by about 50%. Therefore the manufacturing quantity of all the manufacturing processes for fabricating fiber optic joints (31) effectively increases.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A method for fabricating fiber optic joints, the method comprises the steps of:
preparing two fiber optic cables, wherein each fiber optic cable has two ends, a fiber optic filament, and a cover around the fiber optic filament;
stripping the cover off segments of the two fiber optic cables to expose portions of the fiber optic filament in the two fiber optic cables;
twisting the two exposed fiber optic filament of the two fiber optic cables together on a tray that holds the two fiber optic cables, wherein the ends of the two fiber optic cables connect to a light source by a connector connected to a jumper fiber and connect to a light detector;
fusing the two fiber optic fibers twisted together to form an exposed fiber optic joint, and
packaging the exposed fiber optic joint to form a completed fiber optic joint.
